(19) United States
(12) Patent Application Publication
(10) Pub. No.: US 2010/0025181 A1
(43) Pub. Date: Feb. 4, 2010

(54) CLUTCH ARRANGEMENT

(76) Inventor: Frank Guenter, Karlsruhe (DE)

Correspondence Address: MILLER, MATTHIAS & HULL, ONE NORTH FRANKLIN STREET, SUITE 2350, CHICAGO, IL, 60606, US

(21) Appl. No.: 12/524,018

(22) PCT Filed: Feb. 1, 2008
(86) PCT No.: PCT/EP08/00812

§ 371 Date: Jul. 22, 2009

(30) Foreign Application Priority Data
Feb. 3, 2007 (DE) 10 2007 005 461.2

(51) Int. Cl. F16D 25/0638

(52) U.S. Cl. 192/87.11

(57) ABSTRACT

The invention relates to a clutch arrangement having a component which is fixed to a housing, having a piston which is arranged so as to be rotatable about a rotational axis relative to the component which is fixed to the housing, having a hollow cylindrical or annular chamber which surrounds the piston at its end-side region, and having a line arrangement which, for conducting a pressure medium for actuating the piston, leads to the chamber through the component which is fixed to the housing, wherein the chamber is formed as a constituent part of the component which is fixed to the housing and which forms a cylinder, and wherein the piston is arranged in the chamber so as to be rotatable.

The invention relates to a clutch arrangement having the features of the preamble of patent claim 1.

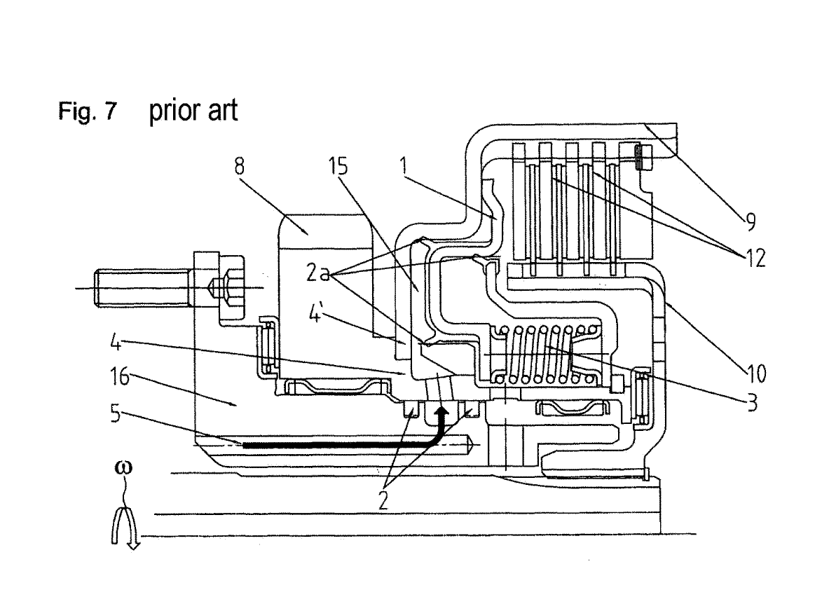

FIG. 7 shows an exemplary single clutch according to the prior art, having a rotating piston 1 in the form of a hollow cylinder whose end side projects into a hollow cylindrical or annular chamber 15 of a hollow cylindrical cylinder 4, 4′ that is formed from a plurality of components. The cylinder 4, 4′ is designed to rotate together with the piston 1 about an axis of rotation relative to components that are fixed with respect to a housing. As an alternative to a clutch arrangement of said type, in which both elements, that is to say the piston 1 and cylinder 4, 4′, rotate about the axis of rotation, cylinder arrangements are also known in which both elements, that is to say the piston and cylinder, are arranged so as to be fixed with respect to the housing.

Such arrangements have several disadvantages. In addition to piston sealing elements 2a, in particular lip sealing elements, for sealing off the piston 1 relative to the wall of the chamber 15, it is additionally necessary to provide rotary leadthrough seals for sealing off the transition of a line arrangement 5 from a component 16, that is fixed with respect to the housing, to the rotating components. In particular the piston sealing elements 2a, that rotate together with the piston 1, harbour the risk of leakage. In particular, the piston seals used in conventional systems require careful assembly, since said piston seals must often be inserted into the cylinder counter to the preferred direction. Here, the lips of a seal of said type can fold over and lead to a total failure of the system. A further significant disadvantage is that of the undesired hysteresis of lip seals.

A further disadvantage of such an arrangement is often the requirement for a centrifugal oil pressure compensation piston. In such designs, a centrifugal oil pressure can build up, which pressure must be compensated by suitable measures, such as for example a restoring spring or a compensation piston. Such a compensation piston is necessary to compensate a centrifugal oil pressure that is generated as a result of rotation in a rotating oil supply duct as a rotating section of the line arrangement.

An actuating piston restoring spring 3 is also imperatively required in order to ensure that the piston 1 is restored counter to the pressure in the chamber across the different rotational speeds that can occur.

It is the object of the invention to propose a clutch arrangement with an improved design, wherein the clutch arrangement should in particular make it possible to dispense with centrifugal oil pressure compensation, or make centrifugal oil pressure compensation necessary only to a reduced extent.

Said object is achieved by means of the clutch arrangement having the features of patent claim 1. Dependent claims relate to advantageous refinements.

Accordingly, a clutch arrangement is preferable that has a component that is fixed with respect to a housing, a piston that is arranged so as to be rotatable about an axis of rotation relative to the component that is fixed with respect to the housing, a chamber that at least partially surrounds the piston, and a line arrangement that, for conducting a pressure medium for piston actuation, leads through the component that is fixed with respect to the housing to the chamber. The clutch arrangement is advantageous in that the chamber is formed as a constituent part of a the component that is fixed with respect to the housing and the piston is arranged at least with its end-side region in a rotatable fashion in the chamber. In other words, the piston rotates in its cylinder that delimits the pressure chamber and that is at the same time stationary and that may thus be formed as a part of the transmission housing or of a component that is fixedly connected thereto. The piston is also advantageously of hollow cylindrical design at least at the end side, and the chamber is of annular or hollow cylindrical design. The chamber correspondingly surrounds the piston preferably in the end-side region thereof.

In a hydraulically actuated clutch arrangement of said design in the form of a single clutch or else multiple clutch, therefore, the predominant part of the piston oil side is stationary. As a result, no centrifugal oil pressure or only a low centrifugal oil pressure is built up. Centrifugal oil compensation against a hydraulic oil that is conventionally used as pressure medium may be dispensed with. In other words, only some of the piston oil used for the pressurization of the piston, or even no piston oil whatsoever, is supplied via line sections that are in rotation about an axis of rotation and that extend, so as to run in the radial direction, to the side of the axis of rotation.

Arrangements are advantageous in which seals, in particular rotary leadthrough seals, are arranged between walls of the chamber and of the piston. Instead of rotary leadthrough seals between stationary rotationally fixed and rotating components in the region of the line arrangement and additional piston seals between the piston and chamber, therefore, the use of only two rotary leadthrough seals that simultaneously permit the axial movement of the piston is adequate. There is practically no risk of additional leakage in the rotating seals, since in contrast to conventional systems, that act purely axially, sealing elements that are conventionally designed as lip seals are dispensed with and the function of the axial mobility is performed by the already-existing rotary leadthrough seals. In particular, assembly is also simplified, since lip seals are no longer required.

A device for centrifugal force compensation may, if necessary at all, be designed to be small and may preferably be provided so as to act only in an upper rotational speed range of the rotatable components. As a result of the design of the non-rotating cylinder, that can be acted on with pressurized oil via a non-rotating oil supply duct in the form of the line arrangement, no significant centrifugal oil pressure can build up, that must conventionally be compensated in conventional systems by means of a centrifugal oil pressure compensation piston or a stronger-dimensioned restoring spring. In the preferred embodiment, therefore, it is possible to dispense with a centrifugal oil compensation device entirely. Alternatively, a compensation arrangement of said type can at least be dimensioned to be smaller, and used for example only at very high rotational speeds.

It is advantageous in particular that, in an arrangement of said type, rotating pistons are permanently in relative movement, and therefore in the event of an axial actuation, have only a very small amount of hysteresis, which is very expedient for the controllability of the overall system.

A further advantage of a clutch arrangement of said type is that an actuating piston restoring spring can be designed to be very weak or may even be dispensed with entirely, since in an embodiment of said type, the piston, as an actuating piston for a plate pack, opens very easily, and is therefore adequately restored even by the opening force in the plate pack. This simplifies the design of a restoring element of said type and increases efficiency, since even at low rotational speeds, the greatest possible proportion of the actuating pressure is also available for the axial pressing of the plate pack and is not partially reduced by the restoring spring.

An arrangement is also advantageous in which an occurring axial force is fed back via a transmission-side shaft and via a bearing of the transmission-side shaft into a housing of the clutch arrangement. Here, the axial forces occurring in gearwheels, that are designed in the conventional way as a helical toothing, can be compensated. It is correspondingly possible for the drive to take place via an input disk or via a sprocket or gearwheel.

The implementation of the advantageous principle of a clutch arrangement of said type is advantageous not only in a single clutch but rather also in multiple clutches. Here, clutches of said type may be formed with or without an integrated torsional vibration damper.

An exemplary embodiment is explained in more detail below on the basis of the drawing. Here, different embodiments are sketched in different figures, with the same reference symbols being used in the different figures to denote identical or equivalent components and/or functions, such that a description is given preferably only on the basis of in each case one individual figure and multiple descriptions with regard to the remaining figures can be dispensed with. In the figures:

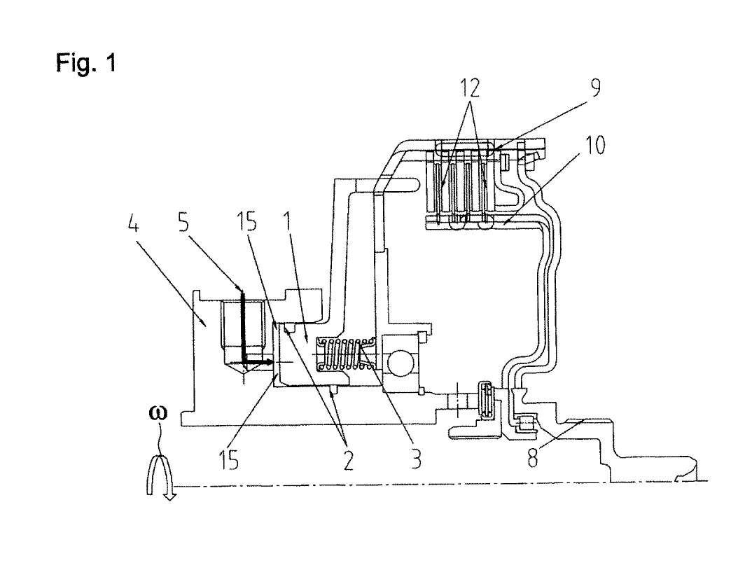

FIG. 1 shows a sectional view through a single clutch with a rotating piston in a stationary cylinder according to a first embodiment, in which an axial force is supported by means of a suitable bearing arrangement in the clutch,

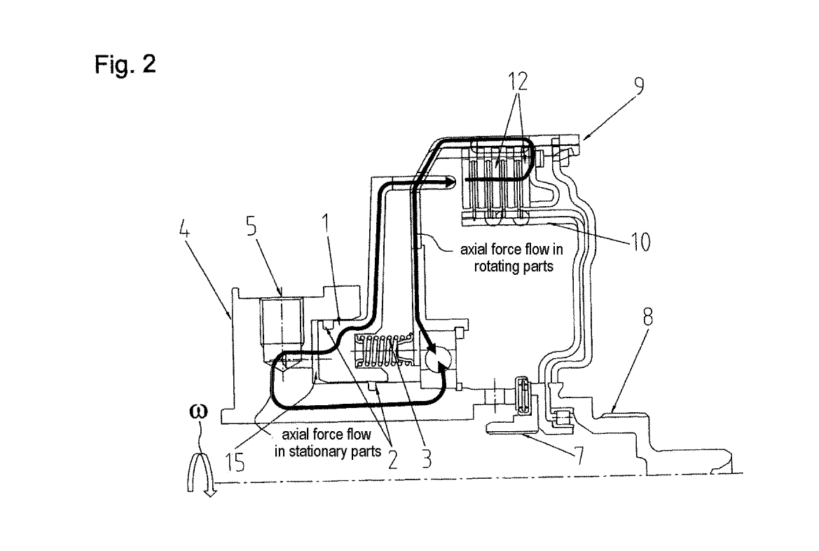

FIG. 2 shows an axial force flow in the event of actuation of the clutch as per FIG. 1,

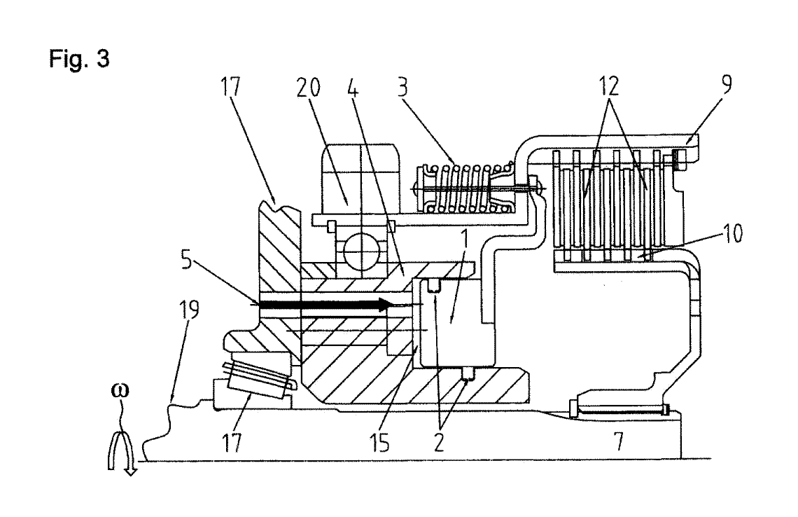

FIG. 3 shows an alternative single clutch with a rotating piston in a stationary cylinder, with the axial force of the clutch actuation being supported by means of a transmission bearing,

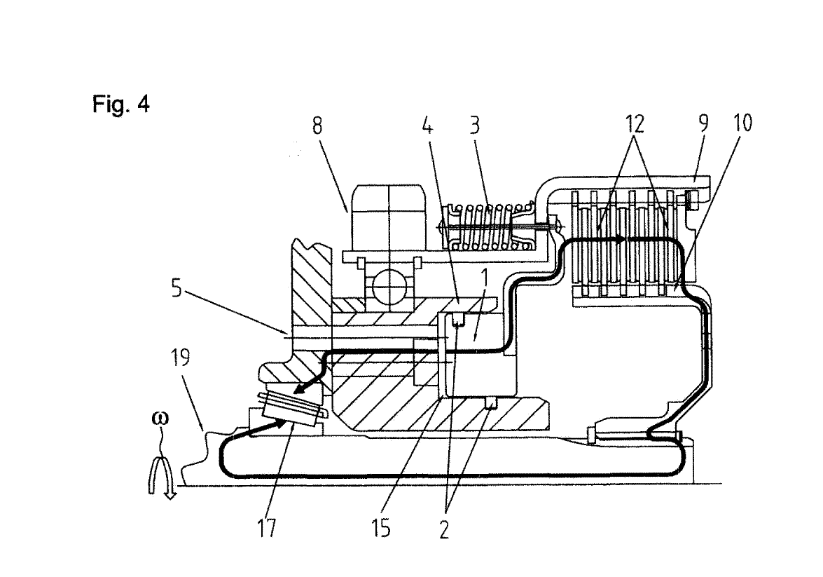

FIG. 4 shows an axial force flow in the event of actuation of the clutch as per FIG. 3,

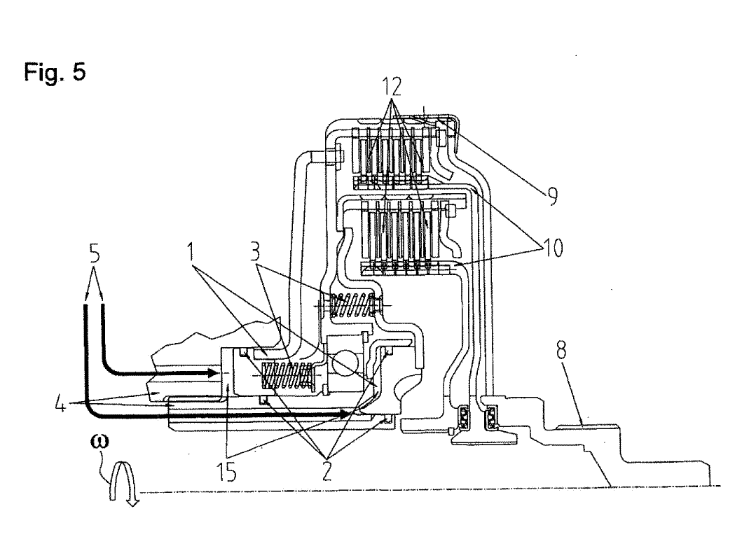

FIG. 5 shows a dual clutch with rotating pistons in a stationary cylinder,

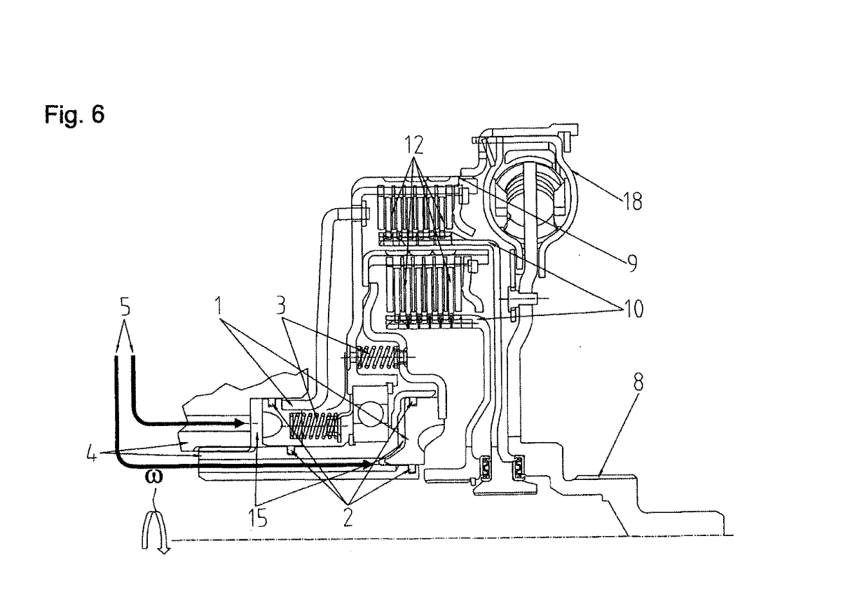

FIG. 6 shows a dual clutch with rotating pistons in a stationary cylinder and with an integrated torsional vibration damper, and

FIG. 7 shows a single clutch with rotating pistons in a rotating cylinder as per the prior art.

As can be seen from FIG. 1 and also from the further FIGS. 2 to 6, in a multiple-disk clutch, an engine torque is transmitted via a drive flange 8 to a drive-side plate carrier 9. By applying an axial force to a plate pack 12, that is arranged in the drive-side plate carrier 9, by means of a hollow cylindrical or annular piston 1, that is embodied as a clutch actuating piston, a friction torque is transmitted in the plate pack 12 to a transmission-side plate carrier 10. Said components are components that are rotationally fixedly mounted together with the drive flange 8 on a drive shaft, such that said components rotate about a common axis of rotation ω. The drive shaft and, via the latter, the drive flange 8, the drive-shaft-side plate carrier 9, the plate pack 12, the transmission-side plate carrier 10 and the piston 1 can therefore be set in rotation together within a housing of a clutch arrangement of said type.

In a conventional way, the piston 1 projects with its end side, that can be acted on with a pressure medium, in particular hydraulic oil, into a hollow cylindrical or annular chamber 15. The chamber 15 is a constituent part of a component 4 that is fixed with respect to the housing and that therefore forms a hollow cylindrical cylinder that is stationary in a transmission or housing. In an arrangement of said type, therefore a cylindrical piston 1 rotates in a chamber 15, that is arranged so as to be fixed with respect to the housing, of the cylinder formed by the component 4 that is fixed with respect to the housing.

Formed between inner and outer walls of the chamber 15 and of the piston 1 are seal elements 2 that may preferably be designed as rotary leadthrough seals. The seal elements 2 are advantageously used both for hydraulically sealing off the rotational movement of the piston 1 relative to the component 4 that is fixed with respect to the housing and also for sealing off the axial movement in the event of a piston actuation of the piston 1.

It is optional, but no longer imperatively necessary in embodiments of said type, for a restoring spring 3 to be arranged at the rear side of the piston 1 in the direction of action. The restoration of the piston 1 may take place, if required at all, directly by means of a suitable spring element in the form of the restoring spring 3 on a web, that likewise rotates at the input rotational speed, of the drive-side plate carrier 9.

A line arrangement 5 for supplying the pressure medium into the chamber 15 may advantageously be guided to the chamber 15 exclusively through non-rotating elements such as the component 4 that is fixed with respect to the housing and that forms the cylinder.

FIG. 2 shows an axial force flow in the event of actuation of the clutch as per FIG. 1. The axial forces are transmitted over a relatively direct and short path, and permit a very small amount of hysteresis as a result of the design of the seals as rotating seals, which enhances the controllability of the system. The short path results in a smaller degree of elasticity of participating components of the system. This results in a further reduction of the hysteresis.

FIG. 3 shows an alternative single clutch with a rotating piston 1 in a stationary cylinder that is again formed by a component 4 that is fixed with respect to the housing. An axial force of the clutch actuation can advantageously be supported by means of a transmission bearing 17.

FIG. 4 shows the force flow, that is directed substantially only axially, in the event of actuation of a clutch as per FIG. 3. Said FIG. 4 illustrates both the axial force flow in stationary parts and also the axial force flow in rotating parts.

FIGS. 3 and 4 therefore show a clutch arrangement in which the occurring axial force is fed back via a transmission-side shaft 19 and via the bearings thereof into the housing. In an arrangement of said type, the axial forces that occur in the gearwheels, that are conventionally designed as a helical toothing, can be compensated. The drive may take place, analogously to the drive via a drive flange as per FIG. 1, via an input disk or via a drive wheel 20, illustrated in FIG. 3, in the form of a sprocket or gearwheel.

FIG. 5 shows a dual clutch with two rotating pistons 1 in a stationary cylinder that is again formed by one or two components 4 that are fixed with respect to the housing with regard to rotational movement. In particular, in an arrangement of said type, too, centrifugal oil pressures are negligible on account of the line guidance of the line arrangement for supplying the pressure media to the chambers.

FIG. 6 shows an exemplary dual clutch with two rotating pistons 1 in a stationary cylinder, with an integrated torsional vibration damper 18 additionally being provided in the clutch arrangement.

All the embodiments are characterized in that the pistons rotate in each case within the associated chambers.

### LIST OF REFERENCE SYMBOLS

1 Piston

2 Seal elements

2a Piston sealing elements

3 Restoring spring

4 Component that is fixed with respect to a housing

5 Line arrangement

8 Drive flange

9 Drive-side plate carrier

10 Transmission-side plate carrier

12 Plate pack

15 Hollow cylindrical chamber

16 Component that is fixed with respect to the housing

17 Transmission mount

18 Torsional vibration damper

19 Shaft

20 Drive wheel ω Axis of rotation

1. A clutch arrangement comprising:
a component that is fixed with respect to a housing,
a piston that is arranged so as to be rotatable about an axis of rotation relative to the component that is fixed with respect to the housing,
a chamber that at least partially surrounds the piston, and
a line arrangement that, for conducting a pressure medium for piston actuation, leads through the component that is fixed with respect to the housing to the chamber, the chamber being formed as a constituent part of the component that is fixed with respect to the housing that forms a cylinder, with the piston being arranged in a rotatable fashion in the chamber.

2. The clutch arrangement as claimed in claim 1, further including seals (2) arranged between walls of the chamber and of the piston in order to hydraulically seal off the rotational movement and the axial movement of the piston.

3. The clutch arrangement as claimed in claim 1, further including a device for centrifugal force compensation, which device provides centrifugal force compensation only in an upper rotational speed range of the rotatable components.

4. The clutch arrangement as claimed in claim 1, wherein an axial force can be fed back via a transmission-side shaft and the bearing thereof into a housing of the clutch arrangement or the transmission housing.

5. The clutch arrangement as claimed in claim 1, wherein said clutch arrangement is formed with at least one further piston as a multi-piston clutch arrangement, with the further piston also being arranged in a rotatable fashion in a chamber, that is assigned to the piston, of a cylinder that is fixed with respect to the housing.

6. The clutch arrangement as claimed in claim 1, wherein the piston is of hollow cylindrical design, in particular of hollow cylindrical design at least at the end side, and the chamber is of annular or hollow cylindrical design.

7. The clutch arrangement as claimed in claim 2, further including a device for centrifugal force compensation, which device provides centrifugal force compensation only in an upper rotational speed range of the rotatable components.

8. The clutch arrangement as claimed in claim 2, wherein an axial force can be fed back via a transmission-side shaft and the bearing thereof into a housing of the clutch arrangement or the transmission housing.

9. The clutch arrangement as claimed in claim 3, wherein an axial force can be fed back via a transmission-side shaft and the bearing thereof into a housing of the clutch arrangement or the transmission housing.

10. The clutch arrangement as claimed in claim 2, wherein said clutch arrangement is formed with at least one further piston as a multi-piston clutch arrangement, with the further piston also being arranged in a rotatable fashion in a chamber, that is assigned to the piston, of a cylinder that is fixed with respect to the housing.

11. The clutch arrangement as claimed in claim 3, wherein said clutch arrangement is formed with at least one further piston as a multi-piston clutch arrangement, with the further piston also being arranged in a rotatable fashion in a chamber, that is assigned to the piston, of a cylinder that is fixed with respect to the housing.

12. The clutch arrangement as claimed in claim 4, wherein said clutch arrangement is formed with at least one further piston as a multi-piston clutch arrangement, with the further piston also being arranged in a rotatable fashion in a chamber, that is assigned to the piston, of a cylinder that is fixed with respect to the housing.

13. The clutch arrangement as claimed in claim 2, wherein the piston is of hollow cylindrical design, in particular of hollow cylindrical design at least at the end side, and the chamber is of annular or hollow cylindrical design.

14. The clutch arrangement as claimed in claim 3, wherein the piston is of hollow cylindrical design, in particular of hollow cylindrical design at least at the end side, and the chamber is of annular or hollow cylindrical design.

15. The clutch arrangement as claimed in claim 4, wherein the piston is of hollow cylindrical design, in particular of hollow cylindrical design at least at the end side, and the chamber is of annular or hollow cylindrical design.

16. The clutch arrangement as claimed in claim 5, wherein the piston is of hollow cylindrical design, in particular of hollow cylindrical design at least at the end side, and the chamber is of annular or hollow cylindrical design.
